(19) United States
(12) Patent Application Publication
(10) Pub. No.: US 2013/0113216 A1
(43) Pub. Date: May 9, 2013

(54) FLOW-BASED ENERGY TRANSPORT AND GENERATION DEVICE

(71) Applicant: Craig Douglas Shrosbree, Lincolnshire (GB)

(72) Inventor: Craig Douglas Shrosbree, Lincolnshire (GB)

(21) Appl. No.: 13/695,892

(22) PCT Filed: May 3, 2011
(86) PCT No.: PCT/IB11/00952

§ 371 Date: Jan. 14, 2013

Related U.S. Application Data
(60) Provisional application No. 61/331,321, filed on May 4, 2010.

(51) Int. Cl. F17D 1/08

(52) U.S. Cl. CPC F17D 1/08
USPC 290/54

(57) ABSTRACT

Energy used to create a fluid flow through a passageway, e.g., a municipal water system, is partially recovered downstream, e.g., at a residential location. An example energy system includes a primary passageway receiving a first fluid from an external source. The primary passageway includes a first region having a first cross sectional area and a second region having a second cross sectional area. The second cross sectional area is different than the first cross sectional area. The first fluid moves from the first region to the second region. A secondary passageway extends from the second region. A turbine is disposed in the secondary passageway. The movement of the first fluid through the primary passageway causes a movement of a second fluid in the secondary passageway, and the movement of the second fluid in the secondary passageway drives the turbine to generate energy.

### CROSS REFERENCE TO RELATED APPLICATIONS

This application claims priority to U.S. Provisional Patent Application No. 61/331,321, filed May 4, 2010, the contents of which are incorporated entirely herein by reference.

### FIELD OF THE INVENTION

The present invention generally relates to energy delivery and energy generation systems. More particularly, the invention employs existing fluid-delivery infrastructure for the transport of energy. The invention allows energy used to create a fluid flow through a passageway to be partially recovered downstream. The invention incorporates the use of one or more specially configured turbines to maximize the energy delivered by the system.

### BACKGROUND OF THE INVENTION

Energy transportation is of great importance as significant infrastructure (e.g., a power grid) is often required to transport energy from an energy source, such as a power plant, to where the energy is required, such as a residential home. In areas lacking the infrastructure to transport energy, enormous time and cost is required to build this infrastructure before any energy transfer can occur. Consequently, it would be of great value to produce the energy closer to the point of energy consumption so as to reduce the loss of energy that occurs when it is transported vast distances from the point of source (e.g., a power station) to point of consumption (e.g., a home or factory). Furthermore, there are multiple environmental benefits to using an alternative energy delivery system, such as reducing pollution, improving air quality, and slowing climate change.

### SUMMARY OF THE INVENTION

Embodiments of the present invention generally relate to energy delivery and energy generation systems. More particularly, embodiments employ existing fluid-delivery infrastructure for the transport and generation of energy. Aspects of the present invention allow energy used to create a fluid flow through a passageway to be partially recovered downstream. Further aspects of the present invention incorporate the use of one or more specially configured turbines to maximize the energy delivered by the system.

According to one embodiment, an energy system includes a primary passageway receiving a first fluid from an external source. The primary passageway includes a first region having a first cross sectional area and a second region having a second cross sectional area. The second cross sectional area is different than the first cross sectional area. The first fluid moves from the first region to the second region. A secondary passageway extends from the second region. A turbine is disposed in the secondary passageway. The movement of the first fluid through the primary passageway causes a movement of a second fluid in the secondary passageway, and the movement of the second fluid in the secondary passageway drives the turbine to generate energy.

According to another embodiment, an energy system includes a fluid, a source that generates a flow of a fluid, a remote location that receives the flowing fluid from the source, and at least one turbine disposed at the remote location. The fluid drives the at least one turbine at the remote location to generate energy.

According to a further embodiment, an energy recovery device includes at least one blade with a magnetic element attached to one end of the at least one blade. The device also includes at least one coil of wire. The at least one blade is disposed proximal to the at least one coil of wire. Movement of the at least one blade generates an electrical current in the at least one coil of wire.

According to yet another embodiment, an energy system includes a primary passageway receiving a first fluid from an external source. The primary passageway includes a first region having a first cross sectional area, a second region having a second cross sectional area, and a third region having a third cross sectional area. The second cross sectional area is different than the first cross sectional area. The third cross sectional area is larger than the second cross sectional area. The first fluid moves from the first region to the second region and to the third region. A hydro-turbine is disposed in the first region. A secondary passageway extends from the second region. A turbine is disposed in the secondary passageway. A tertiary passageway extends from the third region. A turbine is disposed in the tertiary passageway. The movement of the first fluid through the primary passageway causes a movement of a second fluid in the secondary passageway. The movement of the second fluid in the secondary passageway drives a turbine to generate energy. The movement of the first fluid through the primary passageway causes a movement of a third fluid in the tertiary passageway. The movement of the third fluid in the tertiary passageway drives a turbine to generate energy.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIGS. 1a and 1b illustrate a multi-functional energy recovery system unit according to aspects of the present invention.

FIG. 2 illustrates a specially configured turbine assembly used to convert fluid flow into electricity according to aspects of the present invention.

FIGS. 3a and 3b illustrate a reversible flow tube for an energy recovery system according to aspects of the present invention.

FIGS. 4a, 4b and 4c illustrate a bidirectional flow system for energy recovery according to aspects of the present invention.

FIGS. 5a and 5b illustrate a series of turbines to generate energy according to aspects of the present invention.

FIGS. 6a and 6b illustrate an alternative embodiment of the turbine system illustrated in FIGS. 5a and 5b according to aspects of the present invention.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention.

### DETAILED DESCRIPTION

Devices for transporting and recovering energy utilizing the flow of a fluid are disclosed herein. The flowing fluid, such as water in a water main, can be used to generate energy, such as electricity, by directing the fluid through a specially configured passageway.

Various types of fluid flow may be generated. For example, a pumping station may be used to draw water from a natural source, such as a lake, and generate a fluid flow in water pipes for a municipal water system. As another example, fluid flow in a natural body of water, such as a stream, may be generated by rain water delivered to elevated regions. Also, water movement caused by tidal forces can be utilized in estuary locations. In the first example above, the pumping station uses energy from a power plant to move the water and impart the water with kinetic energy. In the second example, the potential energy of the rain water in the elevated regions is converted into kinetic energy as gravity acts on the rain water and the rain water flows down from the elevated regions. In the third example, tidal forces produce kinetic energy as water flows in and out of estuaries in the build up to high tide and low tide phases. In all examples, the generated fluid flow has kinetic energy. As the water flows within the municipal water system or stream, the kinetic energy is delivered to locations that are proximate to the water system or stream. Embodiments according to aspects of the present invention take advantage of such delivery systems and convert the kinetic energy into another form of energy, such as electrical energy or mechanical work. For example, according to aspects of the present invention, a residential home that is connected to a municipal water system can generate electricity using the kinetic energy that is delivered with the water in the water pipes.

Embodiments according to aspects of the present invention provide several advantages. In particular, energy may be effectively delivered to various geographical locations with pre-existing fluid delivery systems. Thus, in addition to delivering water, existing water systems deliver energy that can be converted into electricity. In other words, the embodiments allow a single delivery mechanism to perform multiple functions. Also, the embodiments may provide environmental benefits and energy efficiencies by recovering energy that might otherwise be wasted. Indeed, the embodiments may reduce the need to receive electricity from conventional systems, such as the power grid. Delivery of energy via water pipes is safer and more environmentally friendly than delivery via an electricity grid or a gas pipeline.

Aspects of the present invention allow energy to be transported, and generated at a selected location, by any fluid that flows to that location. As described further below, this is achieved by directing the flowing fluid through a specially configured passageway. As the fluid flows through the passageway, the fluid pressure and fluid velocity is altered. One or more turbines may be disposed in specific regions of the passageway, and the varying pressure and velocity of the flowing fluid can be utilized to rotate the one or more turbines and generate electricity. Additionally, one or more secondary passageways may be connected to the primary passageway, with a turbine disposed in each secondary passageway. The change in fluid pressure in the primary passageway can be utilized to provide a resulting pressure change in the secondary passageway and rotate the turbine disposed therein. By using one or more highly efficient turbines described further below, the energy production from the system may be maximized.

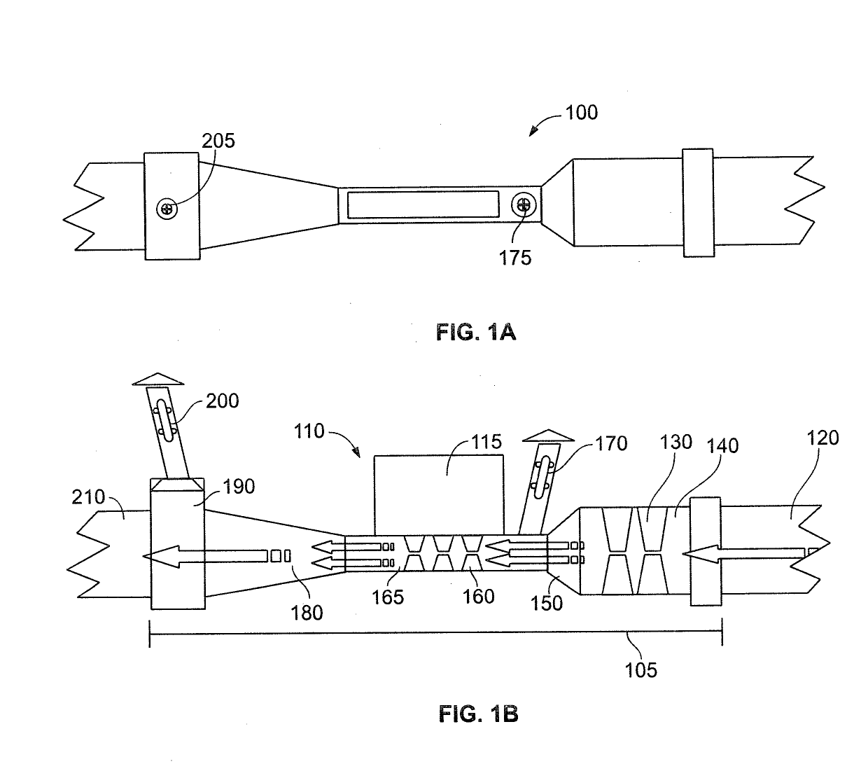

FIGS. 1 to 6 illustrate aspects of a flow based energy transportation and generation device according to the present invention. The present invention is not limited, however, to these specific embodiments.

Turning now to FIGS. 1a and 1b, an exemplary flow based energy transport and recovery system 100 is illustrated. FIG. 1a shows the system from an overhead view. FIG. 1b shows the system from a side view. In FIG. 1b, the horizontal view of the system 110 shows a primary passageway 105 that extends longitudinally and includes an entry point 120 for the entry of a flowing fluid, and an exit point 210 for the flowing fluid. Between the entry point 120 and the exit point 210, the primary passageway 105 includes, in a downstream direction, regions 140, 165, and 190 of varying cross sectional areas. In particular, region 140 has a larger cross sectional area than region 165, and region 165 has a smaller cross sectional area than region 190. The ratios between the cross sectional areas of regions 140, 165, and 190 may be adjusted based on the flow rate to yield optimal output. A frustoconical section 150 connects the region 140 to the region 165. The region 165 is connected to the region 190 by a frustoconical section 180. As described further below, the frustoconical sections 150 and 180 act as Venturi nozzles to change the flow within the primary passageway 105. Furthermore, a secondary passageway 170 extends transversely from the region 165, and another secondary passageway 200 extends transversely from the region 190. Box 115 is attached to region 165 and may be used to house electrical components required by the system.

As further shown by FIGS. 1a and 1b, the system 110 includes turbines 130, 160, 175, and 205. The turbine 130 is disposed in the region 140. A turbine 175 is disposed in the secondary passageway 170 and the turbine 205 is disposed in the secondary passageway 200. Additional turbines 160 may also be disposed in region 165 to draw energy from the flow of the fluid where the velocity of the fluid is the greatest.

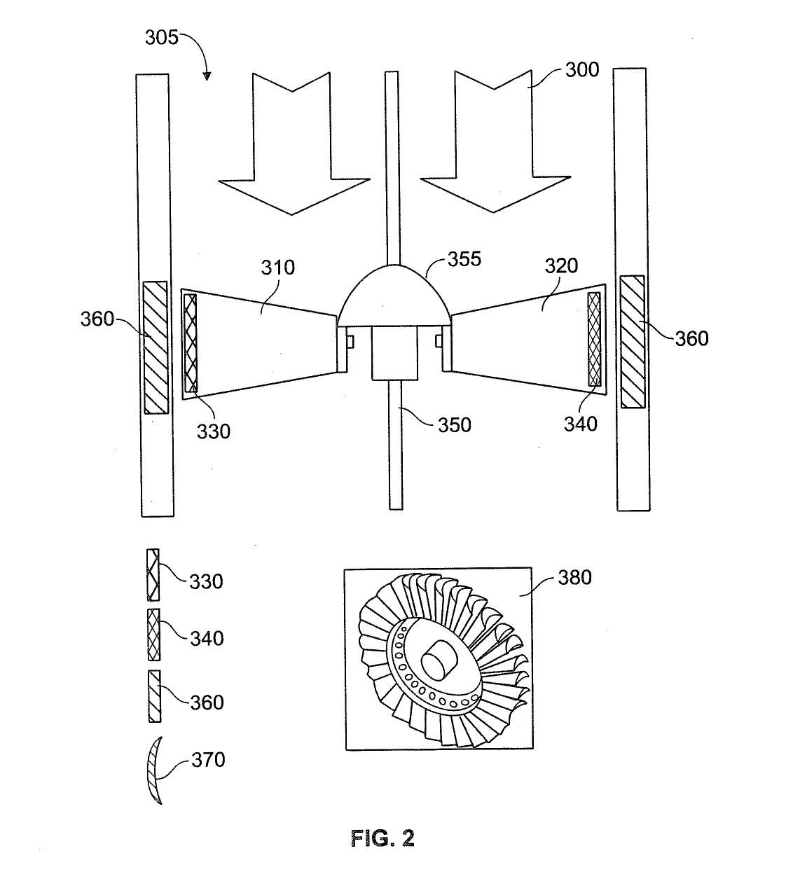

In operation, a fluid passes through the entry point 120 and flows into the first region 140. As described previously, the system 100, for example, may be located in a residential home and the fluid may be water delivered to the system 100 via pipes in a municipal water system. The fluid flows through the turbine 130 and causes the turbine 130 to rotate and generate energy. As described further with reference to FIG. 2, the rotation of the turbine generates electricity in the following manner. Magnets are disposed on the blades of the turbine, so as the blades of the turbine rotate the attached magnets create a magnetic field. This magnetic field affects a coil of wire positioned adjacent to the rotating turbine, causing an electrical current to flow in the coil of wire.

Referring back to the primary passageway 105, the fluid flows through the frustoconical region 150 to the region 165, resulting in increased fluid velocity in region 165 as compared to region 140 according to the Venturi effect. Turbines 160 may be positioned in region 165 to generate additional energy from the increased fluid velocity in this region. The increased fluid velocity in region 165 is accompanied by a resultant reduction in fluid pressure, according to Bernoulli's principle. As a result of the reduction in fluid pressure in region 165, a second fluid, such as air, is drawn in through the secondary passageway 170 and this second fluid rotates the turbine 175 located in passageway 170 and generates energy.

Referring back to the primary passageway 105, the fluid flows from the region 165 through frustoconical section 180 and into the region 190. The flow through the frustoconical section 180 reduces the velocity of the flow according to the Venturi effect. The decreased fluid velocity is accompanied by a resultant increase in fluid pressure, according to Bernoulli's principle. As a result of the increase in fluid pressure in section 190, a second fluid, such as air, is pushed out through the secondary passageway 200 and this second fluid rotates the turbine 205 located in passageway 200 and generates energy.

Accordingly, this system 110 shown in FIG. lb employs velocity and pressure changes in a combination of specially configured passageways to convert energy in four different regions, i.e., at the turbine 130 disposed in region 140, the turbine 160 in region 165, the turbine 175 in the secondary passageway 170, and the turbine 205 in the secondary passageway 200. In particular, the kinetic energy in the fluid flow is converted into electricity which may then be conventionally distributed to the areas of the residential home, facility, etc., where the system 100 is located.

In FIG. 2, a turbine which may be used to generate electricity from the flow of a fluid is disposed in a passageway 305. The walls of the passageway 305 incorporate wire coils 360, with the wire coils positioned such that they are adjacent to the tips of blades 310 and 320. The turbine consists of a central axis 350, a hub assembly 355, the blades 310 and 320, and magnets 330 and 340. The hub 355 is attached to the central axis 350. Each blade 310 and 320 is attached to the hub 355 at one end of the blade, such that the longitudinal section of the blade is perpendicular to the axis 350. Magnets 330 and 340 are disposed at the tips of the blades 310 and 320, on the ends of the blades farthest from the axis 350. Magnets of alternating polarity are used on adjacent blades, with 330 being magnetic north and 340 being magnetic south. The turbine may incorporate many blades 310 and 320, this is demonstrated in view 380.

In operation, a flowing fluid 300, e.g. air or water, exerts a force on the blades 310 and 320, causing the blades to rotate about the axis 350. The rotation of the blades also rotates the magnets 330 and 340 that are attached to the tips of the blades. The rotating magnets 330 and 340 create a magnetic field, and this magnetic field causes an electrical current to flow in the wire coils 360. A turbine with additional blades 310 and 320 may be used, provided that adjacent blades have magnets of opposite polarity 330 and 340 at the tips of the blades. The blades may be formed such that their horizontal cross section is curved in a convex fashion 370, as to increase the rotational velocity of the turbine caused by the flowing fluid. The blade number and configuration may be adjusted to optimize the rotational velocity, e.g. based on whether the fluid is air, water, or another fluid.

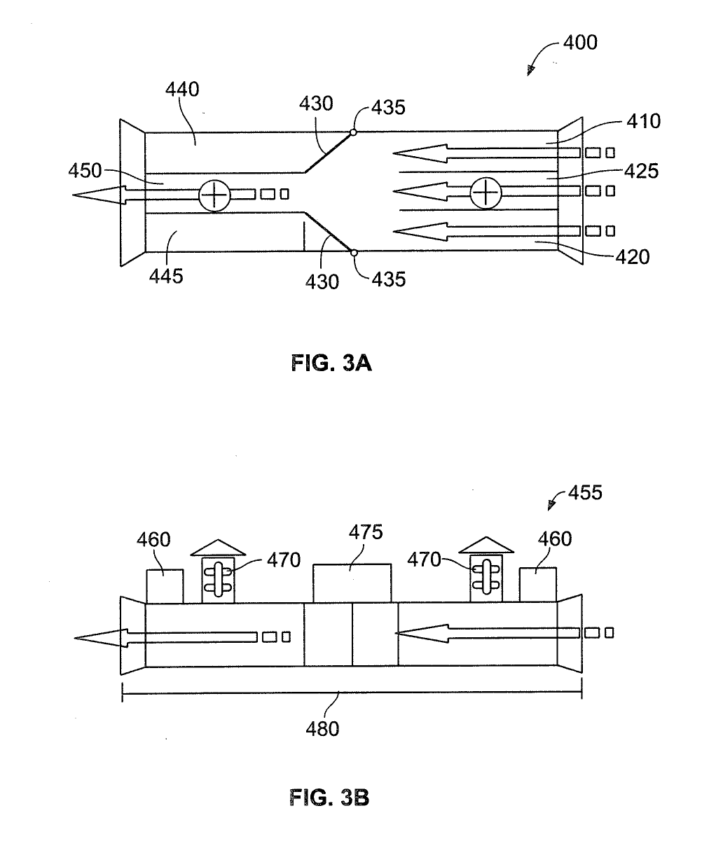

In FIGS. 3a and 3b, another embodiment is shown that allows for reversible fluid flow in the system. This could be used, for example, to generate energy from a tidal flow. The system 400 consists of two moveable gates 430 in the middle of the system. These gates rotate about attachment point 435. The regions immediately to the left and right of the gates 430 are subdivided into three sub regions. Immediately to the right of the gates 430, and on the right side of FIG. 3a, are sub regions 410, 420, and 425 (middle). On the left side of the gates 430, there are sub regions 440, 445, and 450 (middle). The sub regions 410, 420 on the right, 440, 445 on the left, and the gates 430 are configured such that the gates 430 can prevent a flowing fluid in the system 400 from entering the sub regions 410, 420 or 440, 445 when the gates are in their closed positions. For example, if the gates 430 are moved to the far left (the position shown in FIG. 3a), the opening to the right side of sub regions 440, 445 will be blocked off and a fluid flowing from right to left in the system would not be able to flow into the two sub regions 440, 445. Similarly, if the gates 430 are moved to their far right position, a fluid flowing from left to right in the system 400 would not be able to flow into the two sub regions 410, 420.

In operation, fluid flows into the system 400 through the entry point 410. The flowing fluid forces the movable gates 430 to rotate about the attachment point 435 to their extreme left position, thus blocking off the two sub regions 440 and 445, and forcing all the fluid into the region 450. Thus the flow from what is a larger cross section region (incorporating 410, 420 and 425) to the narrower 450 region creates the Venturi effect that may be used to rotate a turbine and generate energy as explained previously. If the flow is reversed, and fluid is forced in through the left side of the system 400, the gates 430 are forced by the fluid flow to the far right position, resulting in a wide section including 440, 445 and 450 on the left flowing into a narrower region 425 on the right, and therefore creating the Venturi effect in the opposite direction. This reversible flow system can be used as part of the system displayed in FIG. 3b, or an alternative embodiment, to allow energy to be harnessed from a fluid flowing from either direction.

FIG. 3b shows a potential embodiment using the reversible system of FIG. 3a. The system of FIG. 3a is displayed as passageway 480 in FIG. 3b. Attached at each end of the passageway 480 are flotation devices 460. In the center of the system, box 475 may be attached to passageway 480 to house electrical components and additional flotation. Also attached to the passageway, extending transverse from the passageway, are two secondary passageways 470 each containing a turbine. The secondary passageways 470 are positioned such that one passageway is to the far left of 480, and the other is to the far right of 480. In operation, the gates described above in FIG. 3a are moved to the far left or far right position, according to the direction of fluid flow, and the flowing fluid through the passageway 480 is used to rotate the turbines in the secondary passageways 470 as described previously.

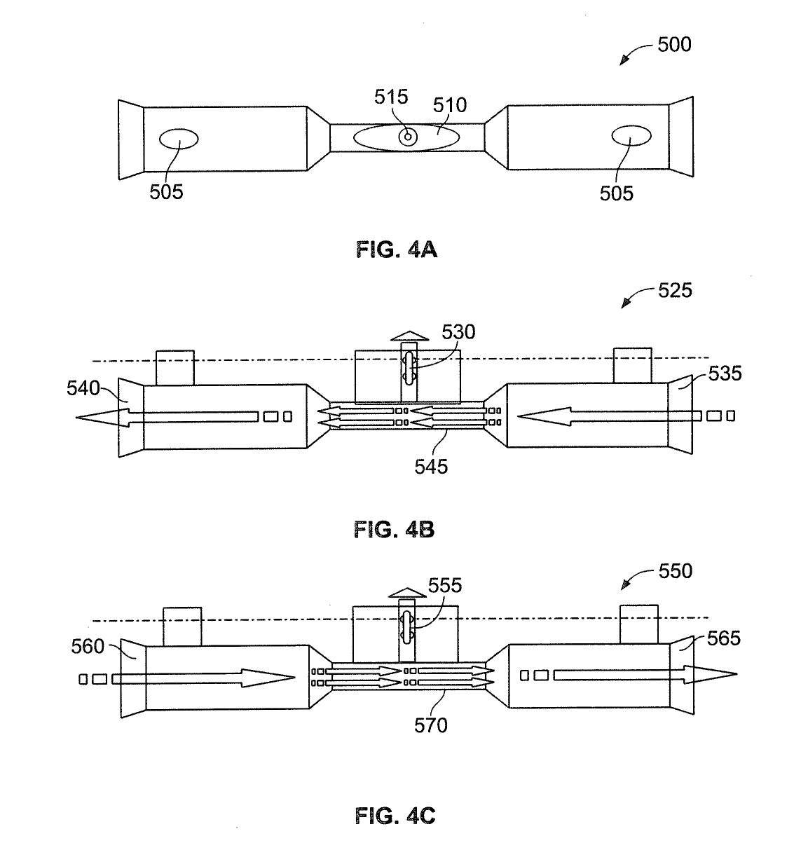

In FIGS. 4a-c, additional embodiments capable of generating energy from bidirectional fluid flow are described. FIG. 4a shows an overhead view of the system 500, which includes flotation modules 505, electrical and flotation housing 510, and a secondary passageway 515 with a turbine therein. Moving to FIG. 4b, a horizontal view of the system, shows the secondary passageway (labeled 530 in this diagram) attached to region 545, and region 545 is in the center of the system 525, with region 540 to the left of 545 and region 535 to the right. In operation, a fluid may flow either right to left (FIG. 4b) or left to right (shown in FIG. 4c). In both cases, the flowing fluid travels from a larger cross sectional area (535 in FIG. 4b, 560 in FIG. 4c) to the smaller cross sectional area region (545 in FIG. 4b, 570 in FIG. 4c), increasing the velocity of the flow according to the Venturi effect. The increased fluid velocity is accompanied by a resultant decrease in fluid pressure, according to Bernoulli's principle. As a result of the decrease in fluid pressure in the middle section (545 in FIG. 4b, 570 in FIG. 4c), a second fluid, such as air, is drawn in through the secondary passageway (530 in FIG. 4b, 555 in FIG. 4c) and this second fluid rotates the turbine located in passageway and generates energy.

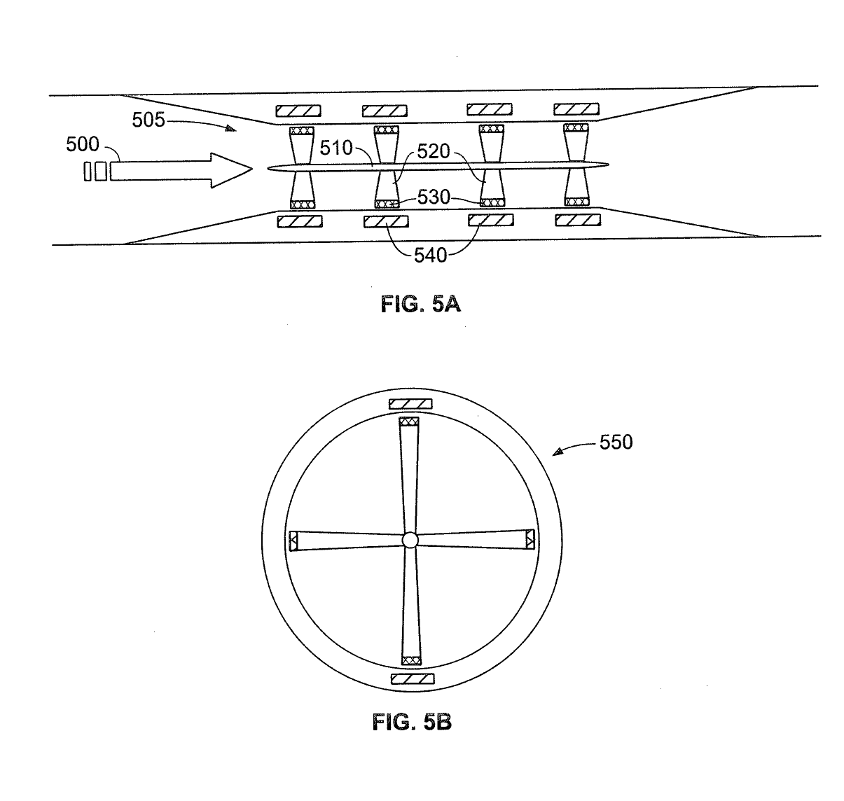

In FIGS. 5a and 5b, a turbine configuration is described. This configuration is essentially multiple instances of the device shown in FIG. 2, connected by a common axis 510. This configuration may be disposed in the smaller cross section region of the system, where the fluid velocity is the greatest (for example, region 165 in FIG. 1). Referring to FIG. 5a, multiple blades 520 are attached to the common axis 510. Each blade 520 has a magnet 530 disposed at the end of the blade farthest from the axis 510. Magnets 530 of alternating polarity—magnetic north and magnetic south—are utilized. The blade and axis assembly is disposed in a passageway 505. Wire coils 540 are positioned in the wall of the passageway 505, in such a manner that the wire coils are adjacent to the magnets 530. In operation, as a flowing fluid 500 enters the passageway 505, the fluid causes the blades 520 and the attached magnets 530 to rotate about the axis 510. The rotation of the magnets 530 creates a magnetic field, which causes an electrical current to flow in the adjacent wire coils 540. FIG. 5b shows a cross sectional view of the system described in FIG. 5a.

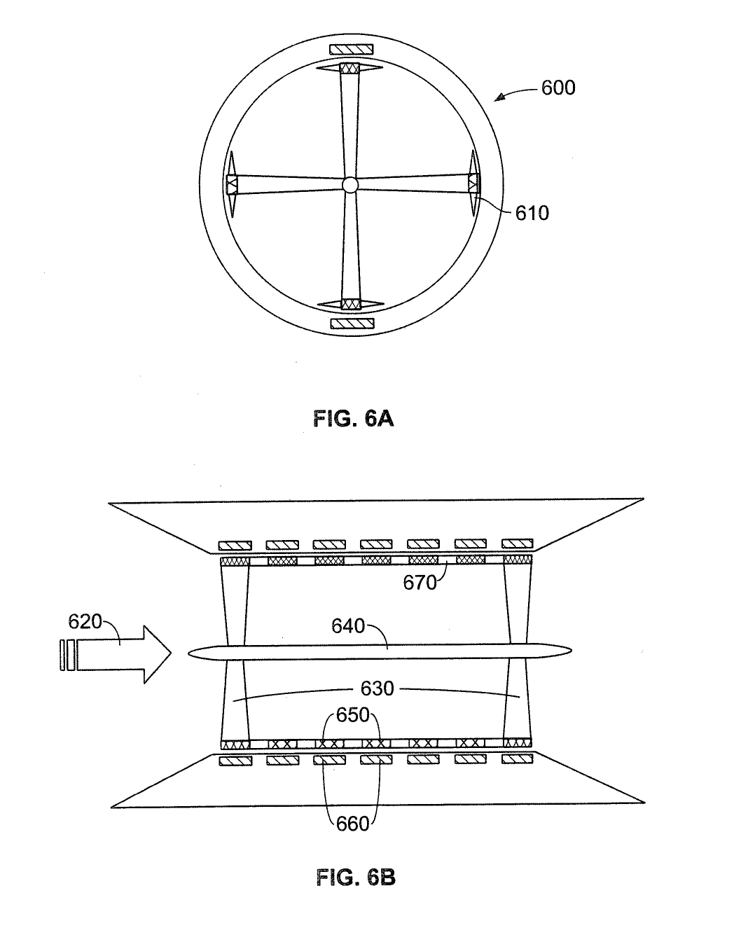

FIGS. 6a and 6b describe an alternative embodiment of the turbine configuration described in FIGS. 5a and 5b. Specifically, the embodiment of FIGS. 6a and 6b uses an aero- or hyrdo-foil connector 670 to connect the ends of each blade 630 at the end farthest from an axis 640. Magnets 650 are positioned along the connector 670. Magnets 650 of alternating polarity—magnetic north and magnetic south—are utilized in the system such that each foil 670 has magnets of the same polarity, and adjacent foils have magnets of the opposite polarity. For each magnet 650, a corresponding wire coil 660 is positioned in the wall of the passageway such that the wire coil is adjacent to the magnet. This embodiment allows a greater number of magnets 650, and corresponding wire coils 660, than blades 630. The greater number of magnets 650 and coils 660 allows more electricity to be generated per rotating blade 630. This turbine configuration may be placed in a narrow region (such as region 165 in FIG. 1) where the fluid velocity is the greatest to optimize output. FIG. 6b shows a cross sectional view of FIG. 6a.

In operation, a flowing fluid 620 enters a region where the turbine configuration of FIG. 6a is positioned. The flowing fluid 620 causes the blades 630 and the attached magnets 650 to rotate about the axis 640. The rotation of the magnets 650 creates a magnetic field, which causes a current to flow in the adjacent wire coils 660.

While the invention has been described with reference to details of the illustrated embodiments, these details are not intended to limit the scope of the invention as defined in the appended claims. For example, the positioning and number of the energy recovery elements can be varied within the system. The disclosed embodiments and obvious variations thereof are contemplated as falling within the spirit and scope of the claimed invention.

The invention is not limited to the generation of electricity; alternatively, the velocity and pressure changes in the system may be directly converted to mechanical work if desired.

Additionally, although the illustrated embodiments use tubing that is generally cylindrical, it should be noted that the cross-section of the tubes shown herein may be other shapes such as rectangular, square, hexagonal, octagonal, other polygonal shapes, or oval.

Furthermore, although embodiments described herein may employ water for a fluid flow, it is understood that any system with a flowing fluid can be used; the invention is not limited to water.

What is claimed is:

1. An energy system, comprising:
a primary passageway receiving a first fluid from an external source, the primary passageway including a first region having a first cross sectional area and a second region having a second cross sectional area, the second cross sectional area being different than the first cross sectional area, the first fluid moving from the first region to the second region;
a secondary passageway extending from the second region;
a turbine disposed in the secondary passageway;
wherein the movement of the first fluid through the primary passageway causes a movement of a second fluid in the secondary passageway, and the movement of the second fluid in the secondary passageway drives the turbine to generate energy.

2. The system of claim 1, wherein an additional turbine is added in the first region to generate energy from the flow of the first fluid.

3. The system of claim 1, wherein an additional turbine is added in the second region to generate energy from the flow of the first fluid.

4. The system of claim 1, wherein the first cross sectional area is larger than the second cross sectional area.

5. The system of claim 1, wherein the first cross sectional area is smaller than the second cross sectional area.

6. The system of claim 1, wherein the first fluid is water and the second fluid is air.

7. The system of claim 1, wherein the direction of flow of the first fluid is reversible.

8. An energy system, comprising:
a source that generates a flow of a fluid;
a remote location that receives the flowing fluid from the source;
at least one turbine disposed at the remote location;
wherein the fluid drives the at least one turbine at the remote location to generate energy.

9. An energy recovery device, comprising:
at least one blade with a magnetic element attached to one end of the at least one blade;
at least one coil of wire, the at least one blade being disposed proximal to the at least one coil of wire;
wherein movement of the at least one blade generates an electrical current in the at least one coil of wire.

10. The device of claim 9, wherein the at least one blade includes multiple blades assembled in a fan assembly.

11. The device of claim 9, wherein the wire is copper wire.

12. The device of claim 9, wherein the at least one blade includes at least two blades, and the respective magnetic elements have opposite polarity.

13. The device of claim 9, wherein the fluid is air.

14. The device of claim 9, wherein the fluid is water.

15. An energy system, comprising:
a primary passageway receiving a first fluid from an external source, the primary passageway including a first region having a first cross sectional area, a second region having a second cross sectional area, and a third region having a third cross sectional area, the second cross sectional area being different than the first cross sectional area, the third cross sectional area being larger than the second cross sectional area, the first fluid moving from the first region to the second region and to the third region;
a hydro-turbine disposed in the first region;
a secondary passageway extending from the second region;
a turbine disposed in the secondary passageway;
a tertiary passageway extending from the third region;
a turbine disposed in the tertiary passageway;
wherein the movement of the first fluid through the primary passageway causes a movement of a second fluid in the secondary passageway, the movement of the second fluid in the secondary passageway drives a turbine to generate energy, the movement of the first fluid through the primary passageway causes a movement of a third fluid in the tertiary passageway, and the movement of the third fluid in the tertiary passageway drives a turbine to generate energy.
